(19) United States
(12) Patent Application Publication
(10) Pub. No.: US 2007/0098351 A1
(43) Pub. Date: May 3, 2007

(54) Methods and computer program products for playing audio/video programs on a portable electronic device

(75) Inventors: Allen M. East, Cary, NC (US); William O. Camp JR., Chapel Hill, NC (US); Daniel P. Homiller, Cary, NC (US)

Correspondence Address: MYERS BIGEL SIBLEY & SAJOVEC, PO BOX 37428, RALEIGH, NC, 27627, US

(73) Assignee: Sony Ericsson Mobile Communication AB

(21) Appl. No.: 11/263,490

(22) Filed: Oct. 31, 2005

(51) Int. Cl. H04N 5/91

(52) U.S. Cl. 386/46

(57) ABSTRACT

Methods of playing audio/video content at a portable electronic. device include playing a first audio/video program, interrupting the playing of the first audio/video program based on a stored user preference, and playing a second audio/video program. Playing of the first audio/video program may be resumed after the completion of the second audio/video program. A computer program product is configured to play a first audio/video program, interrupt the playing of the first audio/video program based on a stored user preference, and play a second audio/video program.

### FIELD OF THE INVENTION

The present invention relates to communications methods, and more particularly, to communications methods and computer program products configured to provide a customized audio/video program for a user of a portable electronic device.

### BACKGROUND

Audio/video content (i.e. audio/video programming), which may include audio content, video content and/or a combination of audio and video content, may be distributed in a number of different ways. For example, analog audio and video content has been delivered for years using AM/FM radio broadcasts and UHFNHF TV broadcasts. More recently, digital audio and video content has been delivered over private satellite broadcast networks, as well as by over-the-air transmission using terrestrial networks. In addition, digital audio/video content has been delivered over data communication networks such as the internet in the form of downloads of encoded audio files, such as MP3 files, as well as via “live” webcasts or streamcasts in which an audio stream is delivered and played in real time or near real time. Digital audio/video content may also be distributed over wireless communication networks, such as cellular and/or PCS networks. In particular, as the bandwidth of wireless communication networks increases and subscriber terminals become more and more sophisticated, the distribution of digital audio and video content over wireless communication networks may increase.

One popular method of distributing audio content over the internet is known as “podcasting,” which allows users to receive a feed of multimedia programs from one or more content providers. Podcasting typically refers to a subscription-based content delivery model that uses a feed to deliver a multimedia program to a subscriber. Podcast subscriptions may be free and/or may be fee-based. Users may subscribe to podcast feeds using “aggregator” software, which may periodically check for and download new content automatically. The aggregator software may reside on a mobile device and/or may enable a user to copy downloaded programs to a mobile device.

Wireless communication between electronic devices may be accomplished using a wide variety of communication media, communication systems and communication standards. For example, portable electronic devices such as mobile telephones are typically configured to communicate via analog and/or digital wireless radio frequency (RF) telephone systems. Such devices may additionally be configured to communicate using wired and/or wireless local area networks (LANs), short range communication channels, such as Bluetooth RF communication channels and/or infrared communication channels, and/or long range communication systems, such as satellite communication systems.

Mobile terminals are typically purchased by a user for the purpose of obtaining access to wireless telephone services through a cellular telephone network. However, as the capabilities of mobile terminals increase, an additional level of user functionality is being included in the hardware and/or software of such mobile terminals. For example, a mobile terminal may be provided with a still and/or video camera, allowing pictures and/or videos to be taken by a user and transmitted from the mobile terminal to others. Likewise, many mobile terminals include personal digital assistant (PDA) type applications suitable for tracking scheduling, tasks and the like. Many mobile terminals also include messaging capability, such as electronic mail (e-mail), short message service (SMS) and multimedia message service (MMS) capabilities. Mobile terminals may also be capable of connecting to the internet by using internet protocol (IP) over wireless and/or wired networks. Thus, as mobile terminals may include sophisticated multimedia display/playback capabilities as well as being able to communicate using multiple protocols and/or communication media, mobile terminals may be ideal platforms for receiving and playing some types of multimedia programs. However, conventional audio distribution systems, such as those described above, have not taken full advantage of the capabilities of such devices.

### SUMMARY

Methods of playing audio/video content at a portable electronic device according to some embodiments of the invention include playing a first audio/video program, interrupting the playing of the first audio/video program based on a stored user preference, and playing a second audio/video program.

Methods according to some embodiments of the invention may further include resuming the playing of the first audio/video program after the completion of the second audio/video program.

Interrupting the first audio/video program may include reducing the volume of the first audio/video program, and wherein playing the second audio/video program may include playing the second audio/video program over the first audio/video program.

The first audio/video program may include a time-scheduled audio/video program, and the method may further include storing the first audio/video program while the second audio/video program is played.

Methods according to some embodiments of the invention may further include detecting a breakpoint in the first audio/video program. In such cases interrupting the playing of the first audio/video program may include interrupting the playing of the first audio/video program at the detected breakpoint.

Methods according to further embodiments may include generating a notification signal upon receipt of the second audio/video program, and receiving a user input in response to the notification signal. In such cases, interrupting the first audio/video program may include interrupting the first audio/video program in response to the user input. Generating the notification signal may include displaying an icon and/or generating an audible announcement.

Methods according to some embodiments of the invention may further include storing the second audio/video program, wherein playing the second audio/video program may include playing the stored second audio/video program.

The second audio/video program may be a broadcast program, and playing the second audio/video program may include receiving the second audio/video program using a receiver and playing the received second audio/video program.

Receiving the second audio/video program may include receiving the second audio/video program from an AM/FM radio broadcast, a UHF/VHF TV broadcast, a DVB-H broadcast or a satellite broadcast. Receiving the second audio/videomultimedia program may further include receiving the second audio/video program via an internet download.

The stored user preference may include one of a programming mix preference and/or a programming priority. The user preference may be heuristically determined based on past user inputs.

The second audio/video program may include a news and/or traffic alert. In some embodiments, the second audio/video program may be received as an RDS data message decoded by an FM radio receiver.

A computer program product for playing audio/video programs on a portable electronic device includes a computer readable storage medium having computer readable program code embodied in said medium, said computer readable program code including computer readable program code configured to play a first audio/video program, computer readable program code configured to interrupt the playing of the first audio/video program based on a stored user preference, and computer readable program code configured to play a second audio/video program.

The computer program product may further include computer readable program code configured to resume the playing of the first audio/video program after the completion of the second audio/video program.

The computer program product may further include computer readable program code configured to detect a breakpoint in the first audio/video program and to interrupt the playing of the first audio/video program at the detected breakpoint.

The computer program product may further include computer readable program code configured to generate a notification signal upon receipt of the second audio/video program, to receive a user input in response to the notification signal, and to interrupt the first audio/video program in response to the user input.

The computer program product may further include computer readable program code configured to store the second audio/video program and play the stored second audio/video program.

The computer program product may further include computer readable program code configured to receive the second audio/video program using a receiver and to play the received second audio/video program.

Some embodiments of the invention provide a portable electronic device configured to perform operations according to embodiments of the invention. Moreover, some embodiments of the invention provide a portable electronic device programmed with a computer program product configured according to embodiments of the invention.

Methods of playing audio/video programs at a portable electronic device according to further embodiments of the invention include defining selected types of audio/video programs, defining a relative priority for first and second types of the selected types of audio/video programs, playing a first audio/video program having the first type of the selected types of audio/video programs, receiving a second audio/video program having the second type of the selected types of audio/video programs, and interrupting the playing of the first audio/video program when the second type of the selected types of audio/video programs has a higher priority than the first type of the selected types of audio/video programs.

### BRIEF DESCRIPTION OF THE DRAWINGS

The accompanying drawings, which are included to provide a further understanding of the invention and are incorporated in and constitute a part of this application, illustrate certain embodiment(s) of the invention. In the drawings:

FIG. 1 is a schematic block diagrams illustrating wireless communication terminals and a cellular communication system in accordance with some embodiments of the present invention; and

FIGS. 2-4 are flow diagrams illustrating operations of communication terminals according to some embodiments of the invention.

### DETAILED DESCRIPTION OF EMBODIMENTS OF THE INVENTION

The present invention now will be described more fully with reference to the accompanying drawings, in which embodiments of the invention are shown. However, this invention should not be construed as limited to the embodiments set forth herein. Rather, these embodiments are provided so that this disclosure will be thorough and complete, and will fully convey the scope of the invention to those skilled in the art. Like numbers refer to like elements throughout. As used herein the term “comprising” or “comprises” is open-ended, and includes one or more stated elements, steps and/or functions without precluding one or more unstated elements, steps and/or functions. As used herein the term “and/or” includes any and all combinations of one or more of the associated listed items.

Embodiments according to the present invention are described with reference to block diagrams and/or operational illustrations of methods and communication terminals. It is to be understood that each block of the block diagrams and/or operational illustrations, and combinations of blocks in the block diagrams and/or operational illustrations, can be implemented by radio frequency, analog and/or digital hardware, and/or program instructions. These program instructions may be provided to a controller, which may include one or more general purpose processors, special purpose processors, ASICs, and/or other programmable data processing apparatus, such that the instructions, which execute via the controller and/or other programmable data processing apparatus, create means for implementing the functions/acts specified in the block diagrams and/or operational block or blocks. In some alternate implementations, the functions/acts noted in the blocks may occur out of the order noted in the operational illustrations. For example, two blocks shown in succession may in fact be executed substantially concurrently or the blocks may sometimes be executed in the reverse order, depending upon the functionality/acts involved.

As used herein, a “communication terminal” (or simply a “terminal”) includes, but is not limited to, a device that is configured to receive/transmit communication signals via a wireline connection, such as via a public-switched telephone network (PSTN), digital subscriber line (DSL), digital cable, a direct cable connection, and/or another data connection/network, and/or via a wireless interface with, for example, a cellular network, a wireless local area network (WLAN), a digital television network such as a DVB-H network, a satellite network, an AM/FM broadcast transmitter, and/or another communication terminal. A communication terminal that is configured to communicate over a wireless interface may be referred to as a “wireless communication terminal,” a “wireless terminal” and/or a “mobile terminal.” Examples of mobile terminals include, but are not limited to, a satellite or cellular radiotelephone; a Personal Communications System (PCS) terminal that may combine a cellular radiotelephone with data processing, facsimile and data communications capabilities; a PDA that can include a radiotelephone, pager, Internet/intranet access, Web browser, organizer, calendar and/or a global positioning system (GPS) receiver; and a conventional laptop and/or palmtop receiver or other appliance that includes a radiotelephone transceiver.

Some embodiments of the invention provide computer program products and methods of operating a terminal having access to a variety of audio/video content sources including, without limitation, stored audio/video content, downloadable audio/video content, streaming audio/video content and/or broadcast/webcast audio/video content. In particular, a computer program product according to some embodiments of the invention may be configured to select an audio/video stream from among the variety of audio/video content sources based on a stored user preference and play the selected audio/video stream at a terminal, thereby providing a custom audio/video program for the user. A computer program product according to some embodiments of the invention may be configured to permit a user to interactively control playback of the audio/video content. For example, a user may skip to the beginning of the next program segment, back to the beginning of the current segment, and/or back to a previous segment using the user interface of the terminal. As used herein, “segment” refers to an element of an individual audio program and could include, for example, a song from a playlist, a chapter in an audio book, a news story in an audio news magazine, etc. User inputs and actions, including which segments are skipped, which segments are selected/repeated, etc., may be stored and analyzed to predict future user preferences, such that the stored user preference may be dynamically updated based on user listening habits.

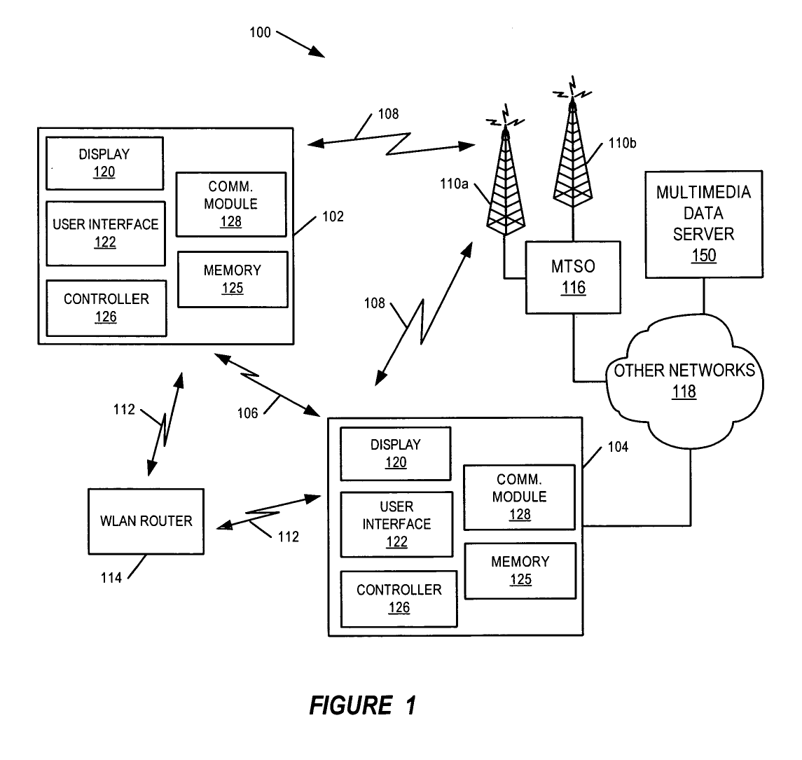

FIG. 1 is a schematic block diagram of a wireless communication system 100 that includes two communication terminals 102, 104 that are configured to communicate data with one another over a direct wireless communication interface 106, over another wireless communication interface 108 through one or more cellular base stations 110a-b, and/or over another wireless communication interface 112 through a wireless local area network (WLAN) access point 114. The direct wireless communication interface 106 may include an RF wireless communication interface such as a Bluetooth interface or an infrared communication interface such as for example, the infrared communication interface defined by the Infrared Data Association (IRDA) protocols. The IRDA defines a number of standards for infrared wireless data communication, including standards for infrared wireless communication at data rates up to 16 Mb/s. It will be appreciated that one or more of communication terminals 102, 104 may be handheld wireless communication terminals such as mobile telephones, PDAs, and the like.

As further illustrated in FIG. 1, the terminals 102,104 may include a display device 120, a user interface 122, a controller 126, a communication module 128, and a nonvolatile memory 125. The display device 120 may be capable of displaying video signals in a video format such as Quarter VGA (QVGA, 320×240 pixels), Common Intermediate Format (CIF, 360×288 pixels) and/or Quarter Common Intermediate Format (QCIF, 180×144 pixels). The terminals 102, 104 may include appropriate CODECs to permit the terminals 102, 104 to decode and display video signals in various formats.

The user interface 122 can include a keypad, keyboard, touchpad, jog dial and/or other user input device. The user interface 122 can also include a microphone coupled to an audio processor that is configured to generate an audio data stream responsive to sound incident on the microphone, a speaker that generates sound responsive to an input audio signal, and/or a camera that captures digital still and/or video images. The communication module 128 is configured to communicate data over one or more of the wireless interfaces 106, 108, and/or 112 to another remote terminal 102,104. The nonvolatile memory 125 is configured to store digital information even when power to the terminal 102, 104 is switched off.

The communication module 128 can include, for example, a cellular communication module, a Bluetooth module, an infrared communication module, and/or a WLAN module. With a cellular communication module, the terminals 102, 104 can communicate via the base stations 110a-b using one or more cellular communication protocols such as, for example, Advanced Mobile Phone Service (AMPS), ANSI-136, Global Standard for Mobile (GSM) communication, General Packet Radio Service (GPRS), enhanced data rates for GSM evolution (EDGE), code division multiple access (CDMA), wideband-CDMA, CDMA2000, and Universal Mobile Telecommunications System (UMTS). The cellular base stations 110a-b may be connected to a Mobile Telephone Switching Office (MTSO) 116 wireless network, which, in turn, may be connected to one or more other networks 118 (e.g. the Internet, a public switched telephone network, and/or another network). With a Bluetooth or infrared module, the terminal 102, 104 can communicate via an ad-hoc network through the direct interface 106. With a WLAN module, the terminal 102, 104 can communicate through the WLAN router 114 using a communication protocol that may include, but is not limited to, 802.11a, 802.11b, 802.11e, 802.11g, and/or 802.11i. One or more of the terminals 102, 104 may also be configured to communicate directly over the networks 118 as shown in FIG. 1.

The terminals 102, 104 may be configured to transmit and/or receive a digital data signal between one another and/or with another communication terminal that may be communicatively coupled thereto through, for example the MTSO 116, and/or another network 118. However, it will be appreciated that data communication between terminals 102,104 may be accomplished without using the MTSO 116 or the PSTN 118.

The terminals 102, 104 my additionally include an AM/FM radio tuner, a UHF/VHF tuner, a satellite radio tuner, a DVB-H receiver, and/or another receiver configured to receive a broadcast audio/video signal.

A terminal 104 may receive an audio/video program from another terminal 102 and/or from a multimedia data server 150, for example, via a network 118. A multimedia data server 150 may transmit an audio/video program to the terminal via a network 118 which, as discussed above may include an audio/video/and or video distribution network 118. The transmission may include a point-to-point transmission to a particular terminal, a point-to-multipoint transmission to a group of selected terminals, and/or a broadcast transmission to arbitrary terminals.

Methods of playing audio/video content at a portable electronic device according to some embodiments of the invention may include storing a first audio/video program, storing a user preference, playing the first audio/video program, interrupting the playing of the first audio/video program based on the stored user preference and playing a second audio/video program. The first audio/video program may be a single audio/video program, such as a single song, and/or may include a sequence of audio/video programs, such as a group of songs in a playlist. After the completion of the second audio/video program, the playing of the first audio/video program may be resumed. The user preference may include, for example, a preference setting indicating that a news and/or informational program may be interrupted at predetermined intervals in order to play, for example, a stored or broadcast music program. In some cases, a user preference may indicate that a program may be interrupted any time an urgent news bulletin is received, such as, for example, a weather bulletin, a financial bulletin, or another type of bulletin.

Some methods may further include detecting a breakpoint in the first audio/video program, such as a chapter mark, the end of a song, the end of a scene, and/or a pause in the audio/video content. Accordingly, the playing of the first audio/video program may be interrupted at the detected breakpoint. Thus, for example, assuming that a user has set a preference indicating that a first program is to be interrupted at a predetermined interval of ten minutes, the first audio/video program may be interrupted at the first breakpoint after the predetermined interval of ten minutes has passed.

While in some embodiments the second audio/video program may not be stored, in other embodiments, the second audio/video program may be stored at the terminal. In such cases, playing the second audio/video program may include playing the stored second audio/video program. For example, in the case where a user preference indicates that a first audio/video program is to be inter rupted if an urgent news bulletin is received, if a first audio/video program is being played but is not at a convenient breakpoint when an urgent news bulletin is received, the terminal may store the urgent news bulletin as a second audio/video program and play the second audio/video program when the first audio/video program reaches a convenient breakpoint. In other embodiments, the volume of the first audio/video program may be reduced and the second audio/video program my be played over the first audio/video program depending, for example, on a stored user preference.

In some cases, the second audio/video program may be a broadcast program. Playing the second audio/video program may include receiving the second audio/video program using a receiver and playing the received second audio/video program. For example, the second audio/video program may be received from an AM/FM radio broadcast, a DVB-H broadcast and/or a satellite radio broadcast. The second audio/video program may also be received by means of an internet download including, for example, a streaming download.

The stored user preference may include, for example, a programming mix, or genre, preference, an interruption preference, and/or a programming priority preference. For example, a user preference could prescribe a mix of news, informational, and/or music programming based on percentage of play and/or time of play. The preference could additionally prescribe a mix of genres for music programs, for example. For example, a user preference could prescribe a mix of 50% rock, 30% jazz and 20% classical music when listening to music programming.

The user preference could additionally set priorities for breaking news alerts. For example, for some types of news alerts could be given a priority that would cause a currently playing audio/video program to be interrupted immediately, while other types of news alerts could be given a priority such that the currently playing audio/video program would not be interrupted until the next breakpoint.

Accordingly, user preferences may generally be categorized as follows:
Music genre preferences (Rock/Pop/Classical/Jazz/etc.), which could also include playlist preferences. For example, a user could create one or more playlists and designate, for example, a relative percentage of time that each playlist is played.
Interruption preferences (wait for breakpoint; pause during interruption). Interruption preferences may define how the terminal handles an update, for example, by waiting for a defined or detected breakpoint and/or by pausing the first audio/video program while the second program is played or reducing the volume of the first audio/video program and playing the second audio/video program over it. Interruption preferences may also be used, for example, to define whether an alert can interrupt an audio program or a video program.
Priority preferences (e.g. priority of news, weather, stock updates, etc.). Priority preferences may be used to define whether certain types of defined updates may be played immediately upon receipt, and/or which types of updates may be played first if simultaneous updates are received. In some cases, priority preferences may be used to override interruption preferences for certain types of updates.

Other types of preferences may also be used to generate a custom audio/video program according to some embodiments of the invention, and not all of the user preferences described above may be included in some embodiments according to the invention. In some embodiments, user preferences may be heuristically determined based on past user inputs. Thus, for example, a music genre preference could be adjusted dynamically based on a user's song preferences, which may be based on the number of times songs of a particular genre are played.

The second audio/video program may be received as, or in response to, a Radio Data System (RDS) data message decoded by an FM radio receiver. RDS is information sent at a low data rate on a subcarrier of the FM signal along with the normal audio. RDS data may be used to transmit information (such as station ID, type of content, etc) about a radio program that may be displayed on the radio digital display. RDS data may also be used to provide or indicate the availability of alerts such as travel alerts, traffic alerts, and news alerts. The RDS data may be converted to digitized speech at the terminal or otherwise used to generate an audio alert.

In some embodiments, a terminal may download one or more podcast audio/video programs in the background while the user is listening to, for example, a custom music mix.

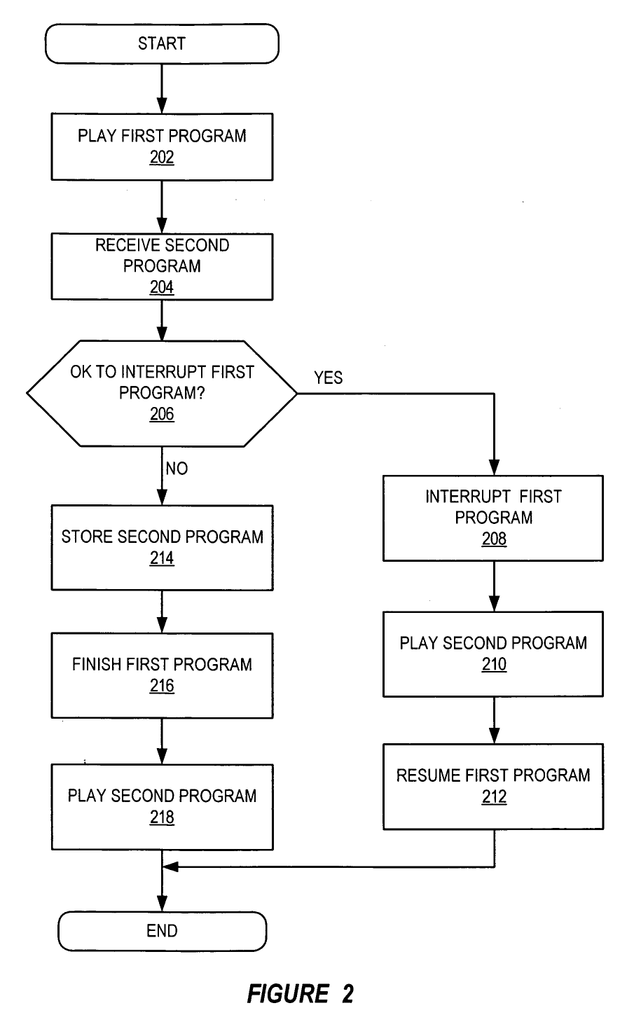

FIG. 2 illustrates operations 200 of a user terminal according to some embodiments of the invention. As illustrated therein, a terminal configured according to embodiments of the invention plays a first audio/video program (block 202). The first audio/video program may include any of a number of audio/video programs from any of a number of sources. For example, the first audio/video program could be a stored MP3 or MPEG file, a streaming audio/video feed, an AM/FM radio broadcast, a UHF/VHF TV broadcast, a satellite radio broadcast or any other type of audio/video program. In some cases, the audio/video program may include selections from one or more playlists stored at the terminal. During playback of the first audio/video program, a second audio/video program is received at the terminal (block 204). A check is made to see if a stored user preference indicates that the second audio/video program is one that may interrupt the first audio/video program (block 206). If so, the user terminal interrupts the first audio/video program (block 208) and plays the second audio/video program (block 210). Interrupting the first audio/video program may include stopping the first audio/video program completely, or it may include reducing the volume of the first audio/video program. Thus, playing the second audio/video program may include playing the second audio/video program over the first audio/video program.

Once the second audio/video program has finished, the playing of the first audio/video program may be resumed (block 212).

If the second audio/video program is not identified as a type that may interrupt the first audio/video program, the second audio/video program may be stored in the background (block 214) while the playback of the first audio/video program is completed (block 216). After playback of the first audio/video program is complete, the second audio/video program may be played (block 218).

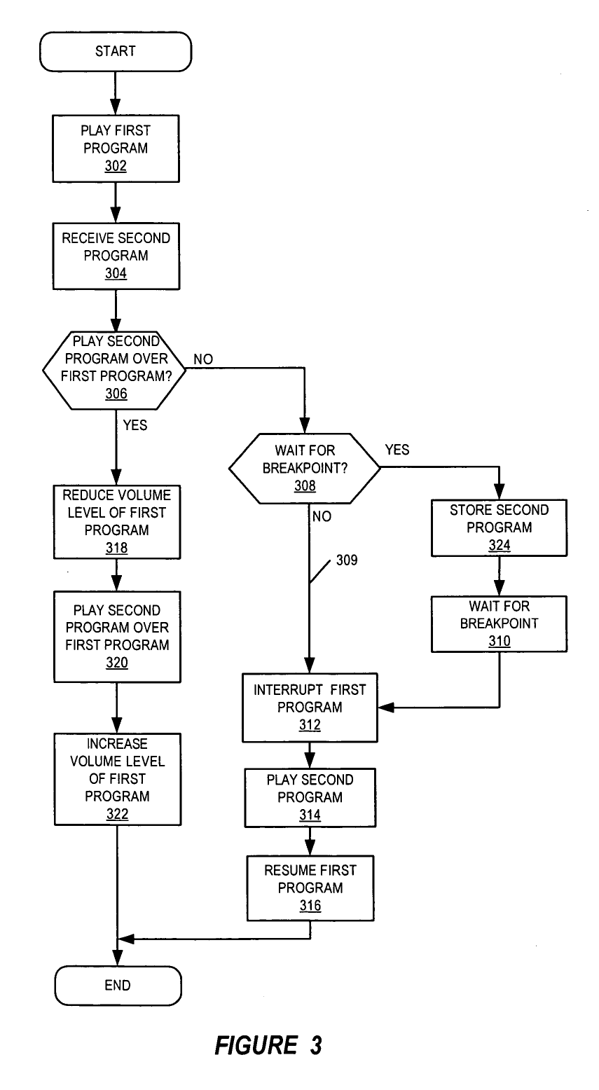

FIG. 3 illustrates operations 300 according to further embodiments of the invention. As shown therein, a first audio/video program is played (block 302). While the first audio/video program is being played, a second audio/video program, such as, for example, a news alert, is received (block 304). Assuming the terminal is configured to interrupt the first audio/video program upon receipt of the second audio/video program, a check is made to see if the second audio/video program is one that should be played over the first audio/video program or not (block 306). If not, a check is made to see if the terminal should wait for the next designated or detected breakpoint before playing the second audio/video program (block 308). For example, a user preference may indicate that weather alerts should interrupt music or video programs without waiting for a breakpoint, but that news alerts should be played only after a breakpoint is reached. In some embodiments, various types of programs could be given a priority level indicating, for example, that they may interrupt a program having a lower priority level.

If the stored user preference indicates that the terminal should wait for a breakpoint, the terminal may store the second audio/video program in the background (block 324) and wait for the breakpoint (block 310) before interrupting the first audio/video program (block 312). The second audio/video program is then played (block 314). After the second audio/video program has finished, playback of the first program is resumed (block 316).

If, however, a user preference indicates that the terminal should not wait for a breakpoint before playing the second audio/video program, the first audio/video program may be interrupted upon receipt of the second audio/video program, as indicated by the line 309 from block 308 to block 312.

If the check at block 306 indicates that the second audio/video program is to be played over the first audio/video program, the volume of the first audio/video program is turned down (block 318) and the second audio/video program is played (block 320) while the first audio/video program plays at a lower volume in the background. After the second audio/video program has finished, the volume of the first audio/video program is turned back up (block 322). These embodiments may be particularly relevant when either the first or the second program is an audio-only program. For example, where the first program is an MPEG film clip, the audio of the first program may be turned down while the second program is played over the speaker. Likewise, where the first program is an audio program, an MPEG film clip may be played while the volume of the first program is turned down.

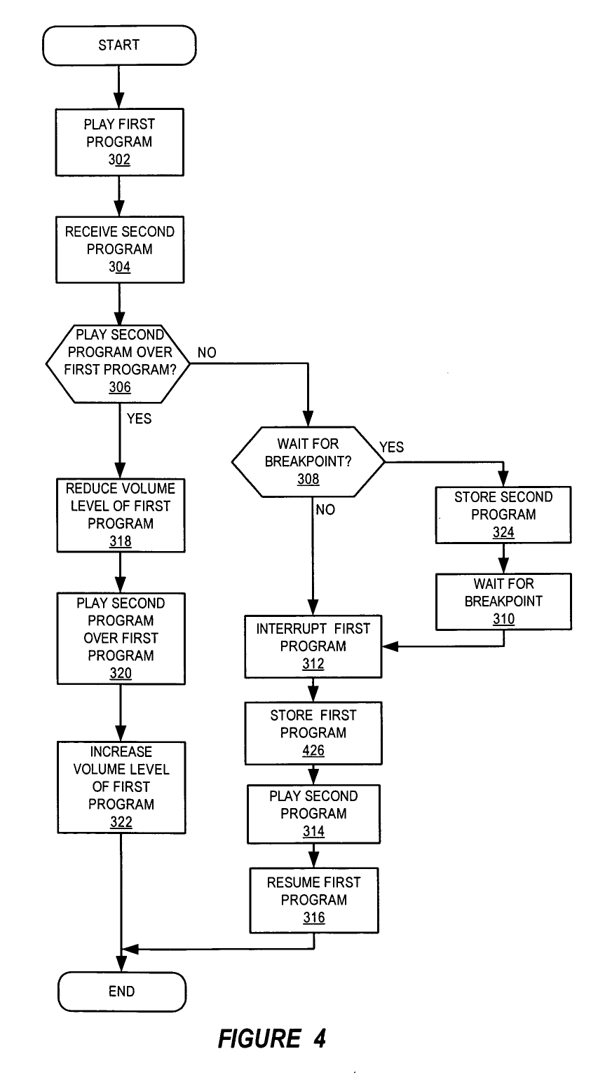

FIG. 4 illustrates operations 400 according to further embodiments of the invention. Operations 400 are similar to operations 300 illustrated in FIG. 3; accordingly, like numbers are used to indicate like operations in the figures. In operations 400, however, when playback of the first audio/video program is stopped at block 312, the first audio/video program may be stored in the background (block 426) while the second audio/video program is played. This may be particularly useful where the first audio/video program comprises a time-scheduled broadcast audio/video program (i.e. a program that is transmitted at a scheduled time and that may not be provided on-demand) such as an audio/video program that is broadcast of the air or one that is streamcast over the internet, as such audio/video programs may not normally be stored as they are played at the receiving terminal.

In some embodiments, instead of waiting for a breakpoint or automatically playing the second audio/video program, the terminal may display an icon and/or generate an audible announcement indicating that a second audio/video program has been received and wait for a user input, such as a keypress, to commence playback of the second audio/video program. Whether or not a type of second audio/video program must wait for user input before being played may be determined by a stored user preference.

In some embodiments, the terminal may keep track of user actions and adjust user preferences accordingly. For example, if a stored user preference indicates that the terminal should wait for a user input before playing a stock alert but the terminal detects that the user always plays stock alerts immediately, the terminal may change the user preference to play such types of alerts immediately upon receipt. Similarly, if a terminal detects that a user frequently skips over songs of a particular genre or songs from a particular playlist, the terminal may automatically adjust the frequency that songs from such playlist and/or genre are played less frequently compared to songs from other playlists and/or genres.

In some embodiments, a relative priority may be defined for selected types of audio/video programs. For example, audio/video programs may be given a priority in the following order of descending priority: Weather alerts, stock alerts, news alerts, video programming, music programming. Interruptions may based on the relative priorities of the audio/video programs. Thus, an incoming stock alert may interrupt the playing of a music program, but may not interrupt a weather alert.

The present invention has been described in part with reference to FIGS. 24, which are flowchart illustrations illustrating exemplary operations for playing a downloaded multimedia program according to aspects of the present invention. It will be understood that blocks of the flowchart illustrations of FIGS. 2-4, and combinations of blocks in the flowchart illustrations, may be implemented using electronic circuits included in communication terminals, such as the mobile terminals 102, 104. It will also be appreciated that blocks of the flowchart illustrations of FIGS. 2-4, and combinations of blocks in the flowchart illustrations, may be implemented using components other than those illustrated in FIG. 1, and that, in general, the blocks of the flowchart illustrations of FIGS. 2-4 and combinations of blocks in the flowchart illustrations, may be implemented in special purpose hardware such as discrete analog and/or digital circuitry, such as combinations of integrated circuits or one or more application specific integrated circuits (ASICs), as well as by computer program instructions which may be loaded onto a computer or other programmable data processing apparatus to produce a machine such that the instructions which execute on the computer or other programmable data processing apparatus create means for implementing the functions specified in the flowchart block or blocks. The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions specified in the flowchart block or blocks.

Accordingly, blocks of the flowchart illustrations of FIGS. 24 support electronic circuits and other means for performing the specified functions/acts, as well as combinations of steps for performing the specified functions/acts. It will be understood that the circuits and other means supported by each block of the flowchart illustrations of FIGS. 2-4, and combinations of blocks therein, can be implemented by special purpose hardware, software or firmware operating on special or general purpose data processors, or combinations thereof.

In the drawings and specification, there have been disclosed embodiments of the invention and, although specific terms are employed, they are used in a generic and descriptive sense only and not for purposes of limitation, the scope of the invention being set forth in the following claims.

What is claimed is:

1. A method of playing audio/video programs at a portable electronic device, the method comprising:
playing a first audio/video program;
interrupting the playing of the first audio/video program based on a stored user preference; and
playing a second audio/video program.

2. The method of claim 1, further comprising:
resuming the playing of the first audio/video program after the completion of the playing of the second audio/video program.

3. The method of claim 1, wherein interrupting the first audio/video program comprises reducing the volume of the first audio/video program, and wherein playing the second audio/video program comprises playing the second audio/video program over the first audio/video program.

4. The method of claim 1, wherein the first audio/video program comprises a time-scheduled audio/video program, the method further comprising storing the first audio/video program while the second audio/video program is played.

5. The method of claim 2, further comprising detecting a breakpoint in the first audio/video program, wherein interrupting the playing of the first audio/video program comprises interrupting the playing of the first audio/video program at the detected breakpoint.

6. The method of claim 2, further comprising generating a notification signal upon receipt of the second audio/video program, and receiving a user input in response to the notification signal, wherein interrupting the first audio/video program comprises interrupting the first audio/video program in response to the user input.

7. The method of claim 6, wherein generating the notification signal comprises displaying an icon and/or generating an audible announcement.

8. The method of claim 1, further comprising storing the second audio/video program, wherein playing the second audio/video program comprises playing the stored second audio/video program.

9. The method of claim 1, wherein the second audio/video program is a broadcast program, and wherein playing the second audio/video program comprises receiving the second audio/video program using a receiver and playing the received second audio/video program.

10. The method of claim 9, wherein receiving the second audio/video program comprises receiving the second audio/video program from an AM/FM radio broadcast, a UHF/VHF TV broadcast, a DVB-H broadcast and/or a satellite radio broadcast.

11. The method of claim 9, wherein receiving the second audio/video program comprises downloading the second audio/video program over a data communication network.

12. The method of claim 1, wherein the stored user preference comprises one of a programming mix preference and/or a programming priority.

13. The method of claim 1, wherein the user preference is heuristically determined based on past user inputs.

14. The method of claim 1, wherein the second audio/video program comprises a news and/or traffic alert.

15. The method of claim 1, wherein the second audio/video program is received as an RDS data message decoded by an FM radio receiver.

16. The method of claim 1, wherein the first audio/video program comprises an audio-only program and the second audio/video program comprises a video program.

17. The method of claim 1, wherein the first audio/video program comprises a video program and the second audio/video program comprises an audio-only program.

18. A computer program product for playing audio/video programs on a portable electronic device, the computer program product comprising:
a computer readable storage medium having computer readable program code embodied in said medium, said computer readable program code comprising:
computer readable program code configured to play a first audio/video program;
computer readable program code configured to interrupt the playing of the first audio/video program based on a stored user preference; and
computer readable program code configured to play a second audio/video program.

19. The computer program product of claim 18, wherein the computer program product further includes computer readable program code configured to resume the playing of the first audio/video program after the completion of the second audio/video program.

20. The computer program product of claim 19, wherein the computer program product further includes computer readable program code configured to detect a breakpoint in the first audio/video program and to interrupt the playing of the first audio/video program at the detected breakpoint.

21. The computer program product of claim 19, wherein the computer program product further includes computer readable program code configured to generate a notification signal upon receipt of the second audio/video program, to receive a user input in response to the notification signal, and to interrupt the first audio/video program in response to the user input.

22. The computer program product of claim 18, wherein the computer program product further includes computer readable program code configured to store the second audio/video program and play the stored second audio/video program.

23. The computer program product of claim 18, wherein the computer program product further includes computer readable program code configured to receive the second audio/video program using a receiver and to play the received second audio/video program.

24. A portable electronic device configured to perform the operations recited in claim 1.

25. A portable electronic device programmed with the computer program product of claim 18.

26. A method of playing audio/video programs at a portable electronic device, the method comprising:
defining selected types of audio/video programs;
defining a relative priority for first and second types of the selected types of audio/video programs;
playing a first audio/video program having the first type of the selected types of audio/video programs;
receiving a second audio/video program having the second type of the selected types of audio/video programs; and
interrupting the playing of the first audio/video program when the second type of the selected types of audio/video programs has a higher priority than the first type of the selected types of audio/video programs.

27. The method of claim 26, further comprising:
resuming the playing of the first audio/video program after the completion of the playing of the second audio/video program.

28. The method of claim 26, wherein interrupting the first audio/video program comprises reducing the volume of the first audio/video program, and wherein playing the second audio/video program comprises playing the second audio/video program over the first audio/video program.

29. The method of claim 26, wherein the first audio/video program comprises a time-scheduled audio/video program, the method further comprising storing the first audio/video program while the second audio/video program is played.

30. The method of claim 26, further comprising detecting a breakpoint in the first audio/video program, wherein interrupting the playing of the first audio/video program comprises interrupting the playing of the first audio/video program at the detected breakpoint.
